(19) United States
(12) Patent Application Publication
(10) Pub. No.: US 2012/0252526 A1
(43) Pub. Date: Oct. 4, 2012

(54) HANDSET UNIT AND TELEPHONE DEVICE

(75) Inventors: TAI-SENG LAM, Taipei City (TW); Chiung-Chi Lin, Taipei City (TW); Li Hsin Tseng, Taipei City (TW)

(73) Assignee: FLYTECH TECHNOLOGY CO. LTD., TAIPEI CITY (TW)

(21) Appl. No.: 13/079,067

(22) Filed: Apr. 4, 2011

(51) Int. Cl. H04W 88/02

(52) U.S. Cl. 455/556.1

(57) ABSTRACT

A telephone device capable of sensing a radio frequency identification (RFID) tag includes: a control module, a display unit, and a handset unit. The control module has a database and a processor electrically connected to the database. The display unit is electrically connected to the processor of the control module. The handset unit has a housing, a telephone module, a radio frequency identification reader, a switch, and a transmitter, wherein the telephone module, the radio frequency identification reader, the switch and the transmitter are disposed in the housing. The telephone module has a listening component and a speaking component. The radio frequency identification reader has a signal transceiver. The switch is selectivity conducting to the telephone module or the radio frequency identification reader. The transmitter is electrically connecting to the processor of the control module and the switch. Thus, the telephone device has radio frequency identification and communicating functions.

### BACKGROUND OF THE INVENTION

1. Field of the Invention

The instant disclosure relates to a handset unit and a telephone device; and more particularly, to a handset unit for a telephone device having radio frequency identification (RFID) reading capability.

2. Description of Related Art

With the rapid advancement in wireless communication technology, research emphasis has been heavily placed on the development of mobile phones. While having a much shorter operational history than its fixed-line counterpart, modern cellular phones have been developed to incorporate handy functional add-ons such as on board cameras, digital music players, and even audio/video recording devices. In comparison, their fixed-line ancestors lag behind in receiving modern technological upgrades.

Therefore, one aspect of the instant disclosure is to provide a handset unit and a telephone device that incorporates the functionality of a RFID reader, thus providing enhanced practical utility over conventional telephone devices.

### SUMMARY OF THE INVENTION

One object of the instant disclosure is to provide a handset unit and a telephone device, wherein the handset unit and the telephone device are provided with radio frequency identification function for making the handset unit and the telephone device more variety.

The telephone device in accordance with the instant disclosure includes a control module, a display unit, and a handset unit. The control module comprises a processor and an associated database for storing a plurality of data that corresponds to one or more RFID tag. The display unit is electrically connected to the control module of the phone system for displaying relevant information. The handset unit has a housing, a telephone module, a RFID reader, a switch, and a transmitter. The telephone module, the radio frequency identification reader, the switch and the transmitter are housed in the housing. The telephone module has a listening component and a speaking component. The radio frequency identification reader has a signal transceiver. The switch selectivity connects the telephone module and the radio frequency identification reader to the transmitter. The transmitter is electrically connecting to the processor of the control module and the switch.

The handset in accordance with the instant disclosure includes: a housing, a telephone module, a radio frequency identification reader, a switch, and a transmitter. The telephone module has a listening component and a speaking component. The radio frequency identification reader has a signal transceiver. The switch is selectivity conducted to the telephone module or the radio frequency identification reader. The transmitter is electrically connected to the switch. The telephone module, the radio frequency identification reader, the switch and the transmitter are disposed in the housing.

The telephone device is particularly suitable for disposing beside a hospital bed to sense a radio frequency identification tag associated with a hospital patient. The instant telephone system includes: a control module, a display unit, and a handset. The control module comprises a processor and an associated database for storing a plurality of patient data. The radio frequency identification tag is configured in correspondence to one of the patient data. The display unit is electrically connected to the control module. The handset has a housing, a telephone module, a radio frequency identification reader, a switch, and a transmitter. The telephone module, the radio frequency identification reader, the switch and the transmitter are disposed in the housing. The telephone module has a listening component and a speaking component. The radio frequency identification reader has a signal transceiver. The switch selectivity connects the telephone module and the radio frequency identification reader to the transmitter. The transmitter is electrically connecting to the control module and the switch. Thus, the signal transceiver can be used for sensing the radio frequency identification tag, and RFID information may be processed by the control module and presented on the display unit.

The instant disclosure provides the handset and telephone device with communicating and radio frequency identification functions.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a schematic view illustrating the handset of the instant disclosure.

FIG. 2 is an exploded schematic view illustrating the handset of the instant disclosure.

FIG. 3 is a functional diagram illustrating the instant disclosure.

FIG. 4 is a functional diagram illustrating the radio frequency identification reader of the instant disclosure.

FIG. 5 is a functional diagram illustrating the wireless transmitter of the instant disclosure.

FIG. 6 is a schematic view illustrating the second embodiment of the instant disclosure.

FIG. 7 is a functional diagram illustrating the second embodiment of the instant disclosure.

FIG. 8 is a schematic view illustrating the third embodiment of the instant disclosure.

FIG. 9 is a functional diagram illustrating the third embodiment of the instant disclosure.

### DETAILED DESCRIPTION OF THE PREFERRED EMBODIMENTS

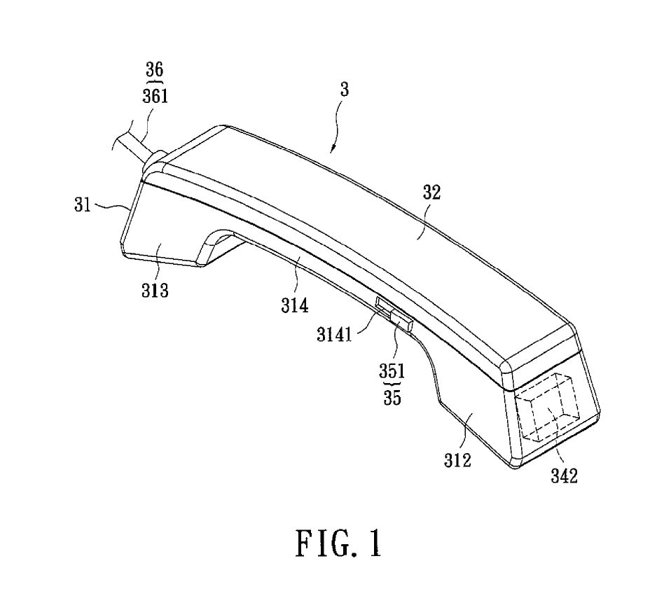

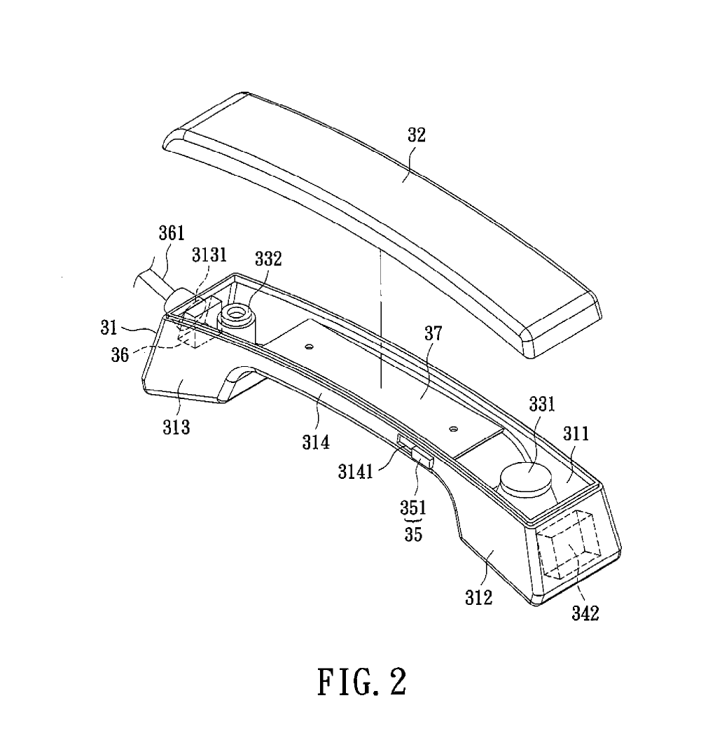

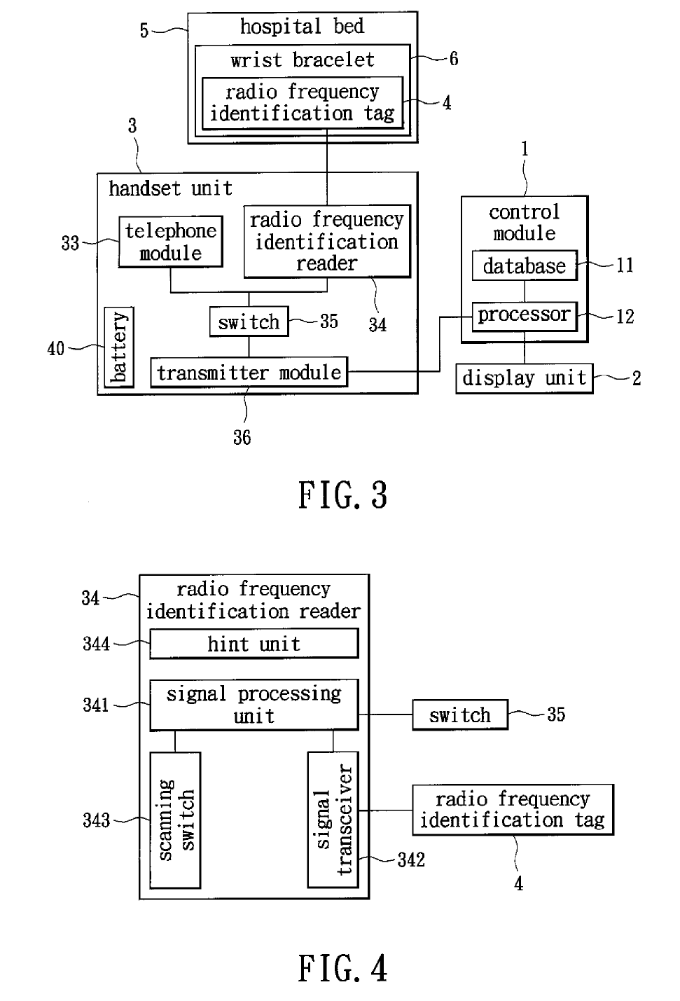

Please refer to FIGS. 1-5, which show the first embodiment of the instant disclosure. As FIGS. 2 and 3 shown, a telephone device could be used to sense a radio frequency identification tag 4 for getting information corresponding to the radio frequency identification tag 4. The telephone device has a control module 1, a display unit 2 electrically connected to the control module 1, and a handset 3.

The control module 1 comprises a processor 12 and an associated database 11. The database 11 is configured for storing a plurality of data, each corresponding to at least one radio frequency identification tag 4. The display unit 2 is electrically connected to the control module 1 for displaying relevant information processed by the processor 12. For example, the processor 12 can transmit data corresponding to the radio frequency identification tag 4 to the display unit 2 for presenting relevant information.

The handset 3 has a housing made of an upper portion 32 and a lower portion 31, a telephone module 33, a radio frequency identification reader 34, a switch 35, and a transmitter 36, wherein the telephone module 33, the radio frequency identification reader 34, the switch 35 and the transmitter 36 are disposed in the housing 31, 32 and respectively has a circuit module (not shown) formed on a circuit board 37 The switch 35 is selectivity conducting to the telephone module 33 or the radio frequency identification reader 34. The transmitter 36 is electrically connecting to the processor 12 of the control module 1 and the switch 35.

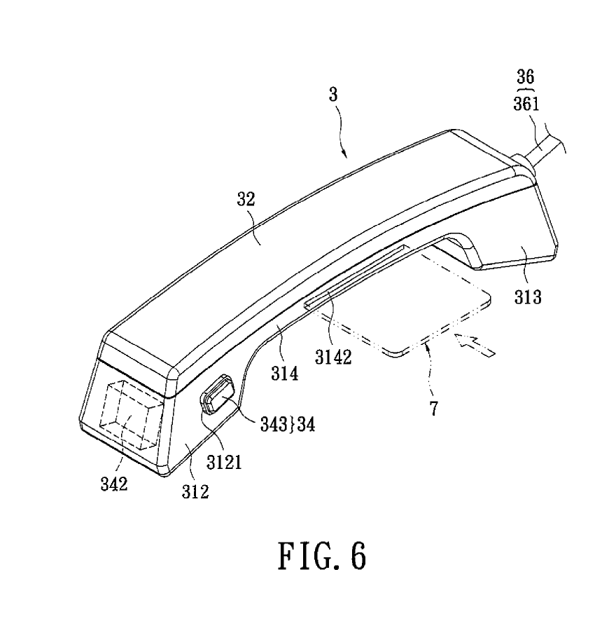

The housing 31, 32 has a recessed base 31 and a cover 32 mounted on the recessed base 31. The recessed base 31 has a handheld portion 314, a listening portion 312 and a speaking portion 313, and the recessed base 31 has an accommodated space 311 formed on the handheld portion 314, the listening portion 312 and the speaking portion 313 thereof. The listening and speaking portions 312, 313 are respectively extended from two ends of the handheld portion 314. The listening portion 312 has a pressing opening 3121 (as FIG. 6 shown) formed thereof. The speaking portion 313 has a transmitting opening 3131 formed thereof. The handheld portion 314 has a switching opening 3141 formed on one side approaching to the listening portion 312 thereof. Besides, the circuit board 37 can be disposed inside the handheld portion 314.

The telephone module 33 has a listening component 331, a speaking component 332, and other necessary electronic components (not shown). The listening component 331 is disposed in the listening portion 312 of the recessed base 31. The speaking component 332 is disposed in the speaking portion 313 of the recessed base 31.

The radio frequency identification reader 34 has a signal processing unit 341, a signal transceiver 342, a starting switch 343, and a hint unit 344 (as FIG. 4 shown). The signal transceiver 342, the starting switch 343, and the hint unit 344 are respectively electrically connected to the signal processing unit 341. The signal transceiver 342 is disposed in the listening portion 312. The starting switch 343 is disposed in the housing 31, 32 and protruded from the pressing opening 3121 of the listening portion 312.

Besides, the radio frequency identification reader 34 can sense a active radio frequency identification tag 4, or a passive radio frequency identification tag 4.

The switch 35 has a switching button 351 disposed in the handheld portion 314 and protruded from the switching opening 3141. The switching button 351 is movably disposed in the switching opening 3141 of the handheld portion 314 for selectivity conducting to the telephone module 33 or the radio frequency identification reader 34.

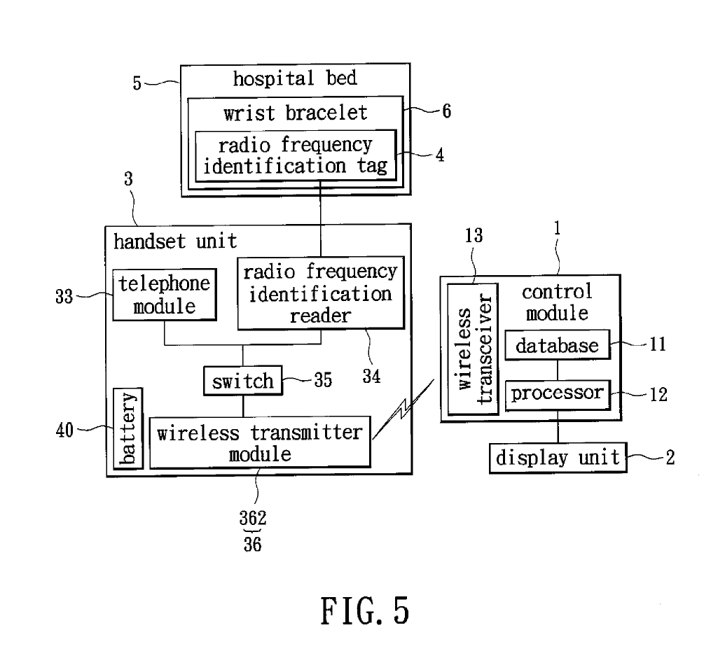

The transmitter 36 is disposed in the speaking portion 313 and corresponded to the transmitting opening 3131 of the speaking portion 313. The handset 3 has a transmission cable 361. One end of the transmission cable 361 is passing through the transmitting opening 3131 to connect to the transmitter 36, and the other end is electrically connected to the processor 12 of the control module 1. Thus, the handset 3 and the control module 1 can be achieved electrically connection and signal transmission with each other. Further, the transmitter 36 can be a wireless transmitter 362 (as FIG. 5 shown), and the control module 1 has a wireless transceiver 13 disposed therein, which the wireless transceiver 13 is electrically connected to the wireless transmitter 362. Thus, the handset 3 and the control module 1 can be achieved electrically connection and signal transmission with each other by wireless connecting type.

If adjusting the switching button 351 to make the switch 35 conducting to the telephone module 33, the handset unit 3 is used for communicating.

If adjusting the switching button 351 to make the switch 35 conducting to the radio frequency identification reader 34, the handset unit 3 is used for sensing the radio frequency identification tag 4. That is to say, when pressing the starling switch 343, the signal transceiver 342 is emitted a electric wave to touch the barcodes 4 of the sensing range, and then the radio frequency identification tags 4 are respectively emitted a electromagnetic wave back. If the signal transceiver 342 is received more than one radio frequency identification tags 4, the radio frequency identification tag 4 closest to the signal transceiver 342 will be handled priority by the signal processing unit 341 The signal processing unit 341 transfers the electromagnetic wave of the closest radio frequency identification tag 4 into a digital signal, and then, the switch 35 and the transmitter 36 transmit the digital signal to the processor 12, the processor 12 is seeking an information corresponded to the digital signal from the database 11, and the processor 12 transmits the information to the display unit 2 for displaying.

If the electromagnetic wave of the closest radio frequency identification tag 4 is transferred to the digital signal, which means the sensing process is achieved, and then the hint unit 344 will produce a beeping to notice the user.

Therefore, the telephone device has a radio frequency identification function to provide a variety using mode. Besides, a battery 40 can be disposed in the handset unit 3 for supplying energy to the above units of the handset unit 3.

Furthermore, the best field for the telephone device of the instant disclosure is related a medical treatment. The telephone device is disposed beside a hospital bed 5 to sense a radio frequency identification tag 4 of a wrist bracelet 6 disposed with a patient laid on the hospital bed 5. The database 11 is stored a plurality of patient data, wherein the radio frequency identification tag 4 is corresponded to one of the patient data. Thus, when a medical staff diagnoses or takes care of the patient, the medical staff can use the handset unit 3 to sense and read the radio frequency identification tag 4 of the wrist bracelet 6, and then the display 2 will be presented the patient data corresponding to the radio frequency identification tag 4 immediately. So that, the medical staff can faster and easier realizes the condition of the patient.

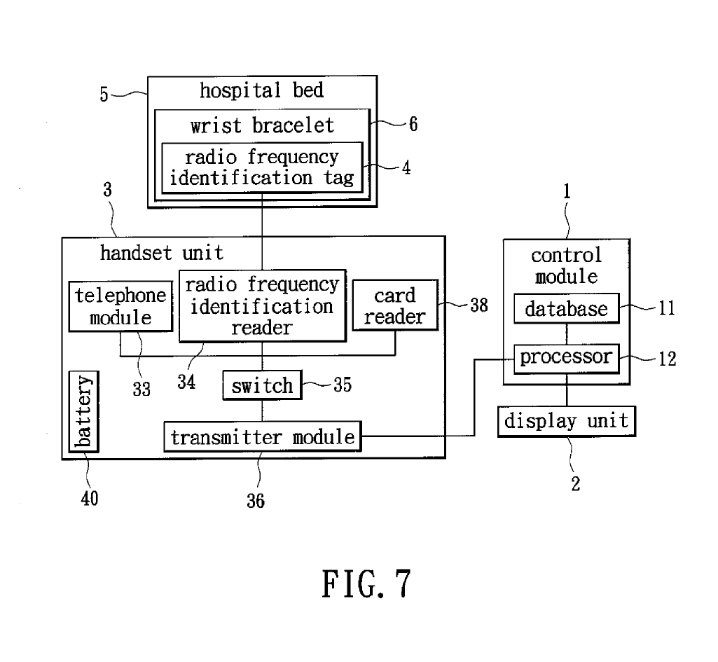

Please refer to FIGS. 6 and 7, which illustrating the second embodiment of the instant disclosure. The difference between the first and second embodiments is as follows.

The handheld portion 314 of the recessed base 31 further has an inserting opening 3142 formed on the other side thereof. The handset unit 3 further has a card reader 38 disposed in the housing 31, 32 and corresponding to the inserting opening 3142 of the handheld portion 314. The circuit module of the card reader 38 can be formed on the circuit board 37. A card 7 can be inserted into the reader 38 via the inserting opening 3142 of the handheld portion 314, the information of the card 7 can be read by the card reader 38.

The switching button 351 is movably disposed in the switching opening 3141 of the handheld portion 314 for selectivity conducting to the telephone module 33, the radio frequency identification reader 34, or the card reader 38.

Besides, the card reader 38 is a type for reading an IC card (such as a credit card, easy card, or health insurance card), or the card reader 38 is another type for reading a memory card or a USB connector (not shown).

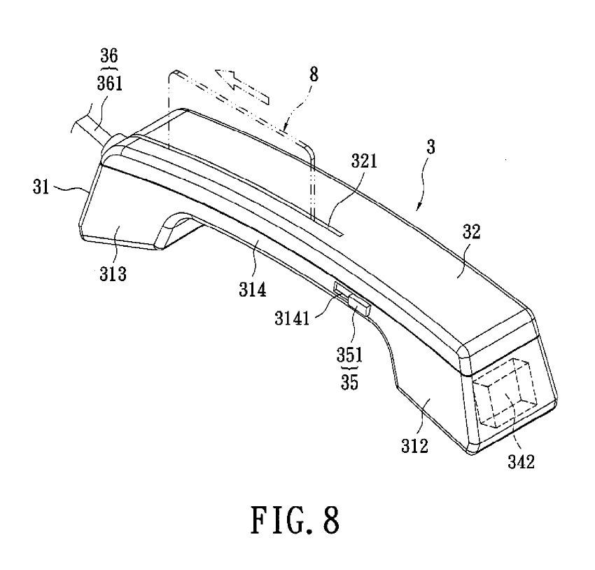

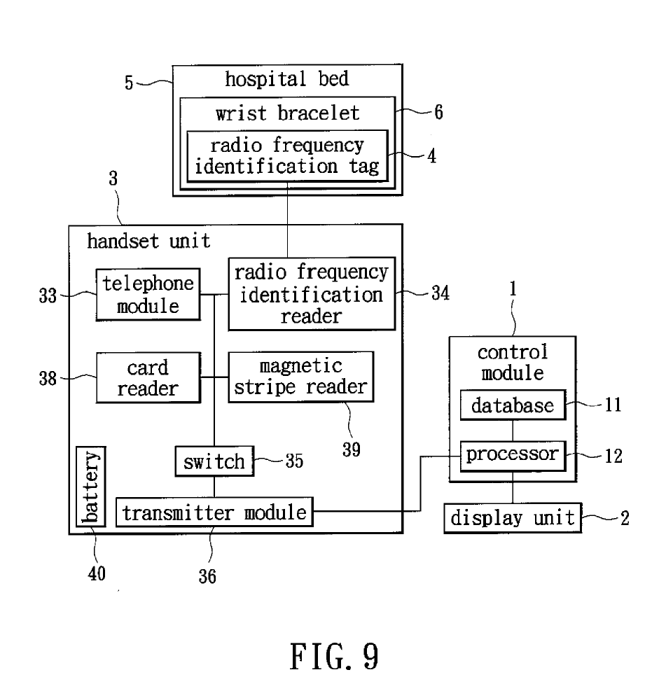

Please refer to FIGS. 8 and 9, which illustrating the third embodiment of the instant disclosure. The difference between the first and third embodiments is as follows.

The cover 32 has an elongated channel 321 formed on a portion corresponded to the listening portion 313 and the handheld portion 314 thereof. The handset unit 3 further has a magnetic stripe reader (MSR) 39 disposed in the housing 31, 32 and corresponding to the elongated channel 321 of the cover 32. The circuit module of the magnetic stripe reader 39 can be formed on the circuit board 37. A magnetic card 8 is swiped through the magnetic stripe reader 39 via elongated channel 321 of the cover 32, the information of the magnetic card 8 can be read by the magnetic stripe reader 39. Besides, the instant disclosure can has the card reader 38 and the magnetic stripe reader 39 at the same time.

The switching button 351 is movably disposed in the switching opening 3141 of the handheld portion 314 for selectivity conducting to the telephone module 33, the radio frequency identification reader 34, the card reader 38, or the magnetic stripe reader 39.

The instant disclosure provides several advantages. First, the telephone device has multi-function, which includes communicating, radio frequency identification, and card-reading, to provide a variety and convenience using mode for the user. Second, the medical staff can faster and easier realizes the condition of the patient by the handset unit 3 or the telephone device with sensing the radio frequency identification tag 4.

The description above only illustrates specific embodiments and examples of the instant disclosure. The instant disclosure should therefore cover various modifications and variations made to the herein-described structure and operations of the instant disclosure, provided they fall within the scope of the instant disclosure as defined in the following appended claims.

What is claimed is:

1. A telephone device capable of sensing a radio frequency identification tag and communicating, comprising:
a control module comprising a processor and an associated database for storing a plurality of data corresponding to at least one radio frequency identification (RFID);
a display unit electrically connected to the control module; and
a handset unit comprising a housing, a telephone module, a radio frequency identification reader, a switch, and a transmitter module, the telephone module, the radio frequency identification reader, the switch and the transmitter module being disposed in the housing,
wherein the telephone module comprises a listening component and a speaking component,
wherein the RFID reader comprises a signal transceiver,
wherein the switch is operably disposed on the housing for establishing selective connection from the telephone module and the radio frequency identification reader to the transmitter module, and
wherein the transmitter module provides signal communication to the control module.

2. The telephone device as claimed in claim 1, wherein the telephone module, the radio frequency identification reader, the switch, and the transmitter respectively has a circuit module formed on a circuit board.

3. The telephone device as claimed in claim 1, wherein the housing has a recessed base and a cover mounted on the recessed base, the recessed base has a handheld portion, a listening portion and a speaking portion, the listening and speaking portions are respectively extended from two ends of the handheld portion, the recessed base has an accommodated space formed thereof, the listening component is disposed in the listening portion, the speaking component is disposed in the speaking portion.

4. The telephone device as claimed in claim 3, wherein the signal transceiver is disposed in the listening portion.

5. The telephone device as claimed in claim 4, wherein the handheld portion has a switching opening formed on one side thereof, the switch has a switching button disposed in the handheld portion and movably disposed in the switching opening of the handheld portion.

6. The telephone device as claimed in claim 3, wherein the handheld portion has an inserting opening formed on one side thereof, the handset unit has a card reader disposed in the housing and corresponding to the inserting opening of the handheld portion.

7. The telephone device as claimed in claim 3, wherein the cover has an elongated channel, the handset unit has a magnetic stripe reader disposed in the housing and corresponding to the elongated channel of the cover.

8. The telephone device as claimed in claim 1, wherein the handset unit has a transmission cable connected to the control module and the transmitter.

9. The telephone device as claimed in claim 1, wherein the transmitter is a wireless transmitter, the control module has a wireless transceiver electrically connected to the wireless transmitter.

10. A handset unit, comprising:
a housing,
a telephone module having a listening component and a speaking component disposed in the housing;
a radio frequency identification (RFID) reader having a signal transceiver disposed in the housing;
a transmitter module disposed in the housing; and
a switch operably disposed on the housing for establishing selective connection from the telephone module and the RFID reader to the transmitter module.

11. The handset unit as claimed in claim 10, wherein the telephone module, the radio frequency identification reader, the switch, and the transmitter respectively has a circuit module formed on a circuit board.

12. The handset unit as claimed in claim 10, wherein the housing has a recessed base and a cover mounted on the recessed base, the recessed base has a handheld portion, a listening portion and a speaking portion, the listening and speaking portions are respectively extended from two ends of the handheld portion, the recessed base has an accommodated space formed inside thereof, the listening component is disposed in the listening portion, the speaking component is disposed in the speaking portion.

13. The handset unit as claimed in claim 12, wherein the signal transceiver is disposed in the listening portion.

14. The handset unit as claimed in claim 13, wherein the handheld portion has a switching opening formed on one side thereof, the switch has a switching button disposed in the handheld portion and movably disposed in the switching opening of the handheld portion.

15. The handset unit as claimed in claim 12, wherein the handheld portion of the recessed base has an inserting opening formed on one side thereof, the handset unit has a card reader disposed in the housing and corresponding to the inserting opening of the handheld portion.

16. The handset unit as claimed in claim 12, wherein the cover has an elongated channel, the handset unit has a magnetic stripe reader disposed in the housing and corresponding to the elongated channel of the cover.

17. A telephone device for disposing beside a hospital bed to sense a radio frequency identification tag associated with a patient, comprising:
a control module comprising a processor and an associated database for storing data corresponding to at least one radio frequency identification (RFID) tag associated with the patient;
a display unit electrically connected to the control module; and
a handset unit comprising a housing, a telephone module, a radio frequency identification reader, a switch, and a transmitter module, the telephone module, the radio frequency identification reader, the switch and the transmitter module being disposed in the housing,
wherein the telephone module comprises a listening component and a speaking component,
wherein the RFID reader comprises a signal transceiver,
wherein the switch is operably disposed on the housing for establishing selective connection from the telephone module and the radio frequency identification reader to the transmitter module, and
wherein the transmitter module provides signal communication to the control module;
wherein in response to the reading of the RFID reader, the processor causes the display unit to present the data associated with the patient.

18. The telephone device as claimed in claim 17, wherein the housing has a recessed base and a cover mounted on the recessed base, the recessed base has a handheld portion, a listening portion and a speaking portion, the listening and speaking portions are respectively extended from two ends of the handheld portion, the recessed base has an accommodated space formed inside thereof, the listening component is disposed in the listening portion, the speaking component is disposed in the speaking portion.

19. The telephone device as claimed in claim 18, wherein the handheld portion of the recessed base has an inserting opening formed on one side thereof, the handset unit has a card reader disposed in the housing and corresponding to the inserting opening of the handheld portion.

20. The telephone device as claimed in claim 18, wherein the cover has an elongated channel, the handset unit has a magnetic stripe reader disposed in the housing and corresponding to the elongated channel of the cover.
